(19) United States
(12) Patent Application Publication
(10) Pub. No.: US 2018/0135843 A1
(43) Pub. Date: May 17, 2018

(54) CARTRIDGE AND SOCKET FOR LIGHT FIXTURES

(71) Applicant: XENIO CORPORATION, San Francisco, CA (US)

(72) Inventors: Howard Herrera, Carlsbad, CA (US); Robert Joseph LaDuca, Dublin, CA (US); Reza Raji, Menlo Park, CA (US); Mark Teitell, Pleasanton, CA (US)

(21) Appl. No.: 15/349,941

(22) Filed: Nov. 11, 2016

(51) Int. Cl. F21V 23/06; H01R 33/74; H01R 13/11; F21V 23/00; F21V 23/02; F21V 23/04

(52) U.S. Cl. CPC F21V 23/06; H01R 33/74; H01R 13/11; H01R 2107/00; F21V 23/02; F21V 23/0435; F21V 23/003

(57) ABSTRACT

A light fixture may include a housing and a light. A socket may be provided at the light fixture, the socketing having an opening configured to receive a removable cartridge and a power connection coupled to at least one power line between a power source and the light. The power connection may be configured to couple the removable cartridge to the at least one power line between the power source and the light when a cartridge is received into the powered socket, and may be configured to form a coupling between the power source and the light when the removable cartridge is removed from the powered socket.

### BACKGROUND

### Field

Aspects of the present disclosure relates generally to a removable cartridge for a light fixture, and more particularly, to an insertable/removable cartridge and a socket at a light fixture for receiving the cartridge.

### Description of the Related Art

Beacons, sensors, cameras, etc. may be deployed in retail locations. For example, beacons may transmit messages, track potential customers, among other features. Substantial costs can be required for the placement of such beacons. An electrician must be hired to run power to the desired location of each beacon. Another professional may be required to install the beacon. Once installed, a beacon cannot be moved without again requiring the cost and labor to uninstall the beacon, run a new power line to the new location, and have the beacon installed at the new location.

While a beacon may be powered using a battery, this limits the abilities of the beacon. For example, the beacon may be limited by the length of time that the battery will power the beacon. The signal of the beacon may be limited in order to conserve the battery. Additionally, battery powered beacons require added maintenance to check battery power and to replace the battery. Battery powered beacons may be placed on a ceiling or a shelf. However, such beacons are less secure than those installed into the ceiling and have an increased potential to fall on customers. Additionally, such beacons have an increased risk of being moved, tampered with, or stolen.

### SUMMARY

The present application addresses these challenges by providing a socket at a light fixture that is capable of receiving an insertable, removable cartridge. The cartridge may be configured to provide a number of potential capabilities. The cartridge may operate similar to a beacon. The cartridge may provide control of the light fixture. The cartridge may provide network connectivity. The cartridge may include any of a radio, camera, audio, or various sensors that are powered through a connection to the light fixture via the socket. Upon insertion of the cartridge, the socket may automatically connect the cartridge to a power source for the light fixture in order to power the components at the cartridge. An empty socket, e.g., upon removal of a cartridge or before a cartridge is inserted, allows the light fixture to operate normally.

A socket may be incorporated into the light fixture at the time of manufacturing. The socket enables the light fixture to be adaptable by receiving a cartridge into the socket. The cartridge may be inserted, removed, and replaced. This enables the light fixture be upgraded at any time simply by inserting cartridge with the desired capabilities As technology changes, the light fixture may be upgraded with a new cartridge. By including a socket in a standard light fixture at the time of manufacture, the light fixture can accommodate future enhancements. At time of purchase and installation, may simply be operated as a light fixture. However, it has the capacity to receive an insertable cartridge that provides power management, network connectivity, a camera, sensors, etc.

A single cartridge can be removed and inserted into another light fixture in order to move the location of the network connection, sensors, transceiver, etc. If the cartridge functions similar to a beacon, the cartridge may be removed and inserted into to a different socket at a different light fixture in order to move the location of the beacon. The aspects presented herein remove the need to have an electrician run a power line to locations for the beacon, and removes the need to install a beacon at a specific location. Instead, a cartridge may simply be inserted into any light fixture having a socket. The cartridge automatically connects to the power of the light fixture and begins to operate.

In an aspect of the disclosure, an insertable cartridge for removable connection with a docking station at a light fixture is presented. For example, the insertable cartridge may include a connection component configured to couple between at least one power source and a light at the light fixture when inserted into the docking station. The insertable cartridge may also include a wireless transceiver configured to operate as a wireless node powered via the connection component.

The connection component may comprise an extension that extends from a housing of the cartridge, wherein, upon insertion into the docking station, the extension is configured to interrupt a first connection between the power line and the light; couple the power line to the cartridge via a first connection; and couple the cartridge to the light via a second connection.

In another aspect, an insertable cartridge for removable connection with a docking station at a light fixture is presented. For example, the insertable cartridge may include a connection component configured to couple between at least one power source and a light at the light fixture when inserted into the docking station and a power management component that is powered via the connection component. The connection component may couple between a control signal, e.g., a control power line and the light. The power management component may be configured to control the light.

In another aspect, a powered socket at a light fixture is provided. For example, the powered socket may include an opening configured to receive a removable cartridge and a power connection coupled to at least one power line between a power source and a light. The power connection may be configured to couple the removable cartridge to the at least one power line between the power source and the light when a cartridge is received into the powered socket. The power connection may also be configured to form a coupling between the power source and the light when the removable cartridge is removed from the powered socket.

In another aspect, a light fixture is provided. For example, the light fixture may comprise a housing and a light provided within the housing. The light fixture may also comprise a socket including an opening configured to receive a removable cartridge and a power connection coupled to at least one power line between a power source and a light. The power connection may be configured to couple the removable cartridge to the at least one power line between the power source and the light when a cartridge is received into the powered socket. The power connection may also be configured to form a coupling between the power source and the light when the removable cartridge is removed from the powered socket.

Additional advantages and novel features of aspects of the present invention will be set forth in part in the description that follows, and in part will become more apparent to those skilled in the art upon examination of the following or upon learning by practice thereof.

### BRIEF DESCRIPTION OF THE DRAWINGS

FIG. 1 illustrates an example cartridge and socket in accordance with aspects presented herein.

FIG. 2 illustrates an example light fixture having a socket in accordance with aspects presented herein.

FIG. 3A illustrates a view of an empty socket in accordance with aspects presented herein.

FIG. 3B illustrates a cross section of an empty socket in accordance with aspects presented herein.

FIG. 4A illustrates a view of a socket having an inserted cartridge in accordance with aspects presented herein.

FIG. 4B illustrates a cross section of a socket having an inserted cartridge in accordance with aspects presented herein.

FIG. 5A illustrates a detail view of a set of contacts of an empty socket in accordance with aspects presented herein.

FIG. 5B illustrates a detail view of a set of contacts of a socket having an inserted cartridge in accordance with aspects presented herein.

FIG. 6 illustrates a diagram of a lighting system in accordance with aspects presented herein.

FIG. 7 illustrates a detail view of a set of contacts of a socket having an inserted cartridge in accordance with aspects presented herein.

FIG. 8 illustrates wireless communication with a cartridge at a light fixture in accordance with aspects presented herein.

FIG. 9 illustrates a lighting system with a modular cartridge in accordance with aspects presented herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

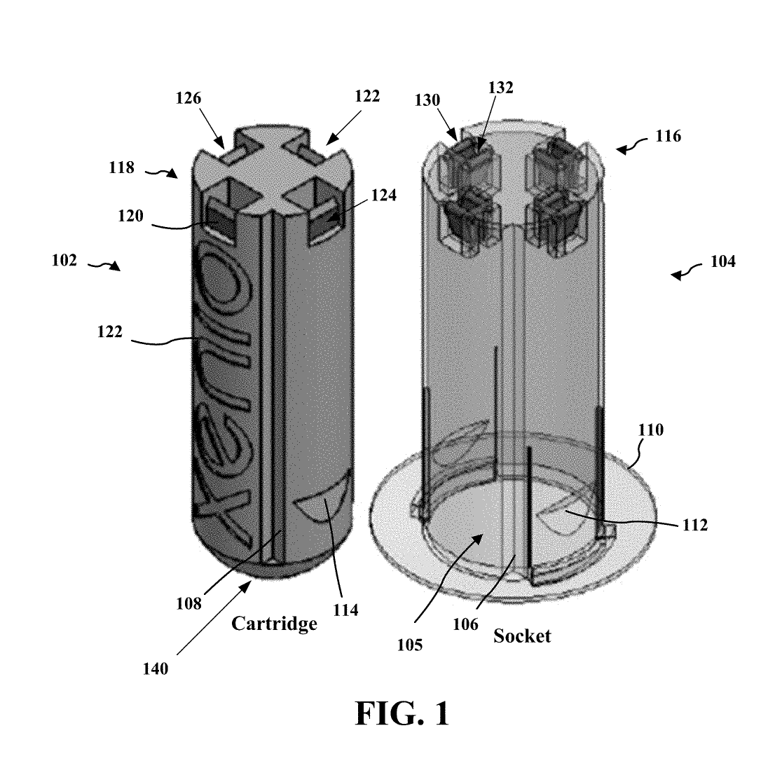

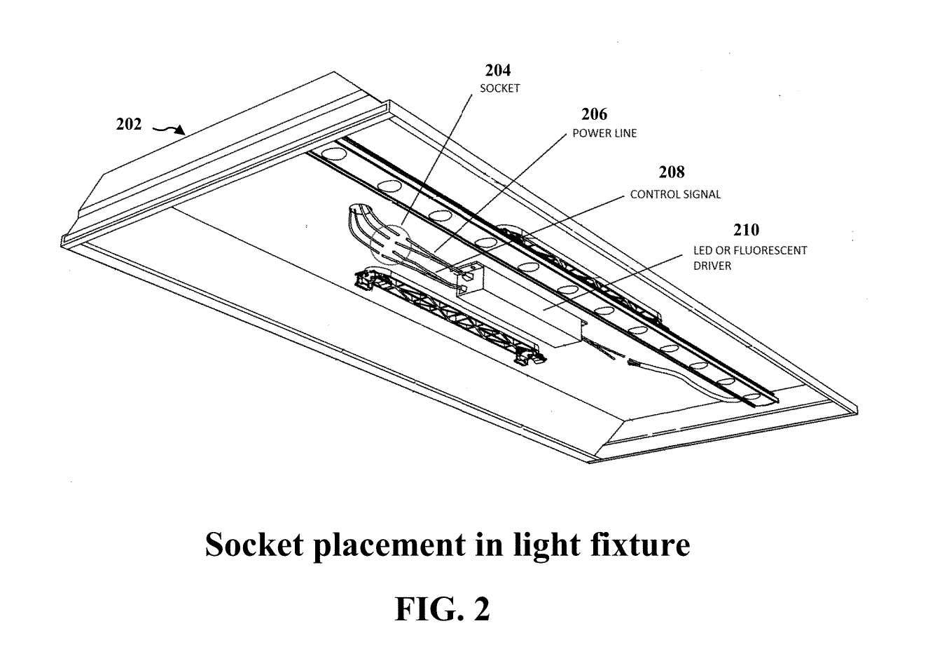

FIG. 1 illustrates an example cartridge 102 and an insertable, removable socket 104 for a light fixture. The socket 104 may also be referred to interchangeably herein as a “docking station” for the cartridge 102. FIG. 2 illustrates an example socket placement in a light fixture 202. The location of the socket 204 is illustrated with a circle interrupting power line 206 and control line 208 prior to the power or control signal reaching the driver 210. The socket positioned at 204 may be socket 104 from FIG. 1. Socket 104 comprises an opening 105 configured to receive cartridge 102. FIG. 1 illustrates an example socket having a cylindrical shaped housing surrounding a central opening 105 for receiving the cartridge 102. Cartridge 102 may be configured with a shape corresponding to the opening of the socket 104 so that the cartridge can be inserted, e.g., by sliding, into the socket 104.

The socket 104 provides an electrical connection to cartridge 102 by coupling the cartridge 102 between a power source of a light fixture and a light comprised in the light fixture upon insertion of the cartridge. When a cartridge is removed from socket 104, the socket reestablishes a direct connection from the power source to the light. Thus, upon insertion of a cartridge 102, power is provided from the power source and through the cartridge before reaching the light. This powers the components comprised in the cartridge 102. When the socket is empty, the socket functions as a pass through and merely provides a connection between the power source and the light.

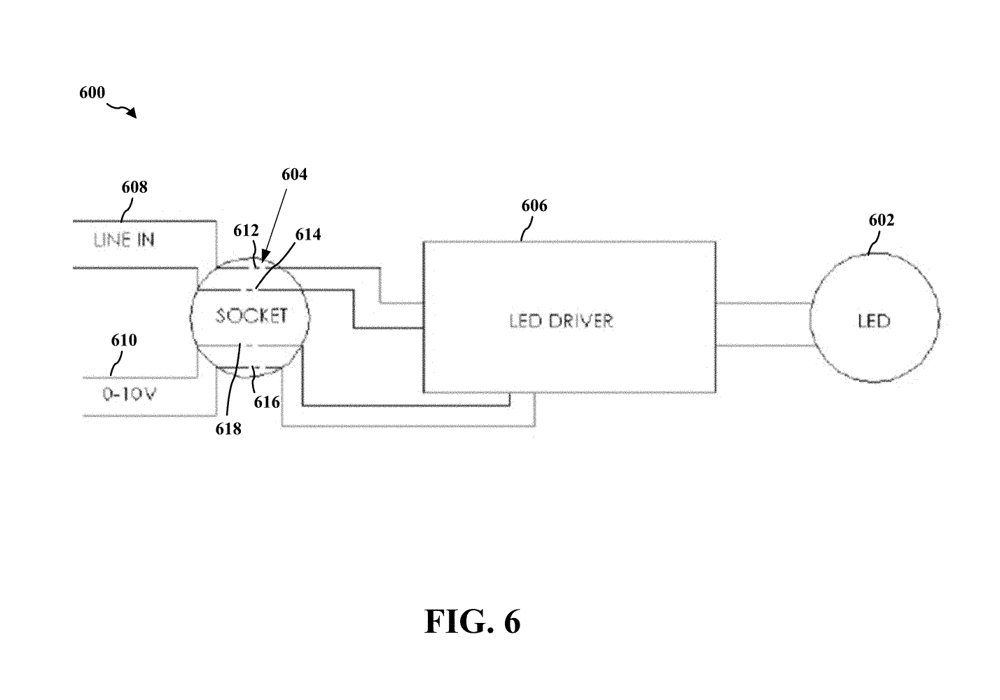

Socket 104 may comprise a power connection portion 116 opposite the opening 105. The power connection portion 116 may be configured to couple the removable cartridge 102 to the at least one power line, e.g., 608, 610, between the power source 608, 610 and the light 602 when a cartridge 102 is received into the powered socket 104, e.g., as illustrated in FIG. 6. The power connection portion 116 may also be configured to form a coupling between the power source 608, 610 and the light 602 when the removable cartridge 102 is removed from the powered socket 104.

The cartridge 102 may similarly comprise a connection component portion 118 configured to couple between at least one power source 608, 610 and a light 602 at the light fixture when inserted into the socket 104. For example, the connection component 118 may comprise an extension 120 that extends from a housing 122 of the cartridge 102. Extension 120 may also be referred to herein as a “connector” or “pin.”

For example, the power connection portion 116 may include a set of contacts, e.g., a first contact 130 biased toward a second contact 132 to form a first electrical connection. Receipt of the cartridge into the powered socket may press the first contact 130 and the second contact 132 apart, breaking the first electrical connection. When no cartridge is received in the socket, e.g., upon removal of the cartridge, or prior to insertion of the cartridge from the powered socket, the first contact 130 and the second contact 132 automatically reestablish the first electrical connection due to the bias pressing the set of contacts toward each other.

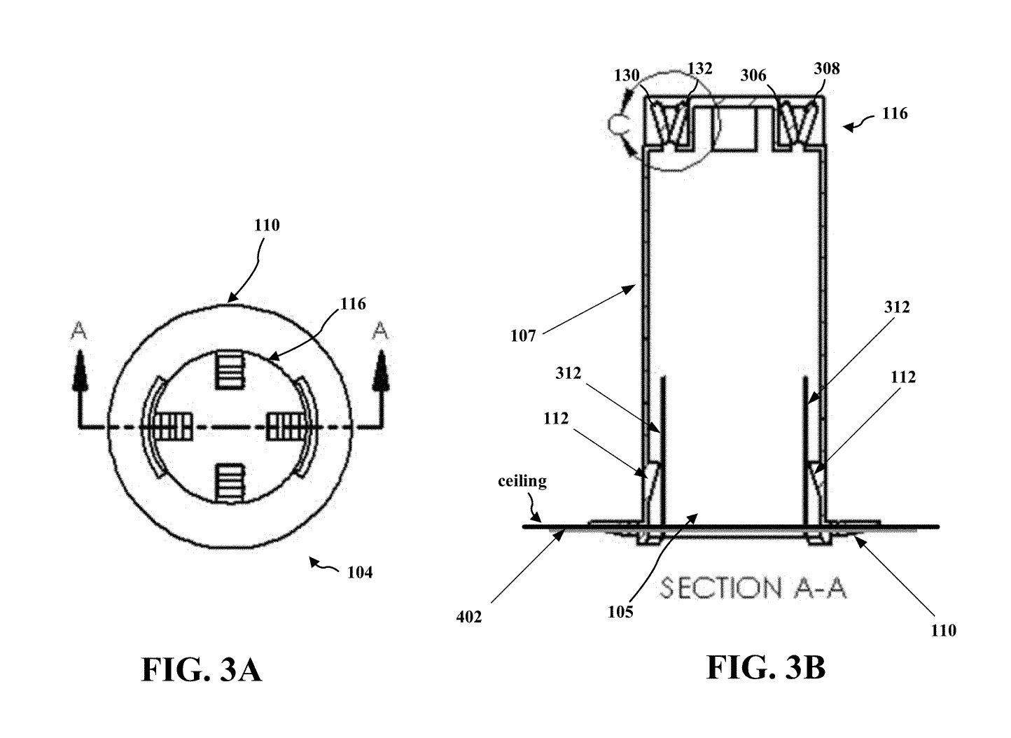

FIG. 3A illustrates a view of an empty socket 104 from a side the power connection portion 116. FIG. 3B illustrates a cross section of the socket 104 taken along the dashed line in FIG. 3A. FIG. 3B illustrates the socket comprising a cylindrical housing 107 surrounding a central opening 105 configured to receive the cartridge 102. The socket 104 may be housed within the light fixture. For example, FIG. 3B illustrates the flange 110 of the socket 104 that surrounds the initial opening 105 being placed at ceiling level. The body e.g., housing 107, of the socket 104 may be within the housing of the light fixture. FIG. 3B illustrates a first contact 130 and a second contact 132 biased toward each other and forming an electrical connection. For example, the first contact 130 may be coupled to a power source 608, 610 for powering the light 602 at the light fixture. The second contact 132 may be coupled to the light 602. When the first contact 130 and the second contact 132 make contact with each other, the power source powers the light at the light fixture.

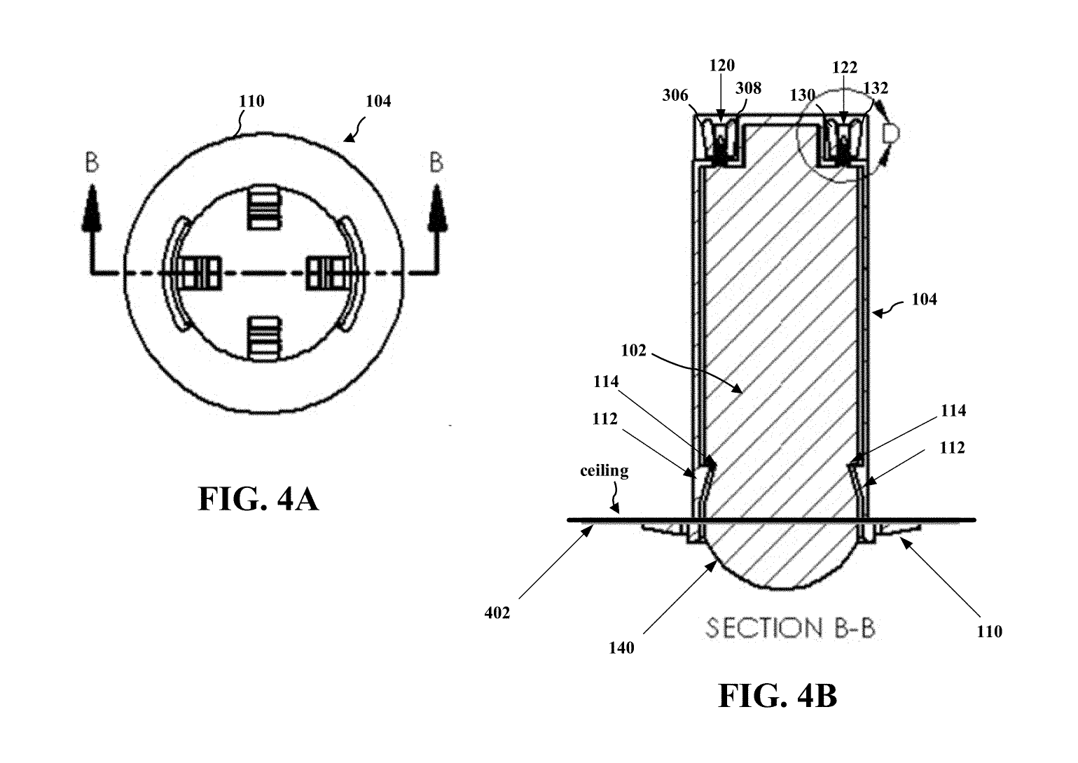

FIG. 4A illustrates a view of a socket 104 similar to FIG. 3B only having a cartridge 102 inserted therein. The view in FIG. 4A is from the power connection portion 116 side of the socket 104. FIG. 4B illustrates a cross section of the socket 132 taken along the dashed line in FIG. 4A. In FIG. 4B, the extension 122, e.g., pin, of the cartridge 102 has pressed the first contact 130 and the second contact 132 apart. In pressing the set of contacts 130, 132 apart the extension 122 forms a first connection with the first connector 130 and forms a second connection with the second connector 132. The set of contacts 130, 132 are biased toward each other, which also causes them to be biased toward the sides of the extension 122. The electrical connection that used to be formed by the contact between the set of contacts 130, 132, as in FIG. 3B is interrupted and the power connection now flows through the cartridge 102, thereby powering the components comprised in the cartridge.

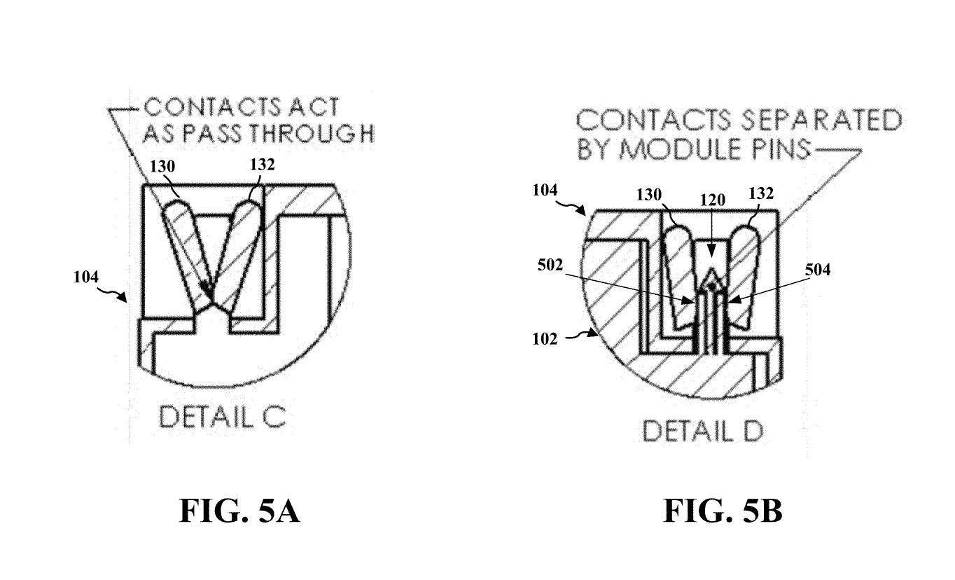

For example, the extension 120 at the connection component 118 of cartridge 102 may interrupt a first connection between the power source, e.g., the power line entering the light fixture, and the light, e.g., by pressing the first and second contacts 130, 132 apart. The extension 120 may comprise a first side that couples to the power source via a contact, e.g., 502 in FIG. 5B. The extension 120 may comprise a second contact that couples to the light via third connection, e.g., 504 in FIG. 5B. The two contacts on the extension 120 of the cartridge may be separated by an insulator. FIG. 5A illustrates a detailed view of a set of contacts in an empty socket 104, e.g., biased together to act as a pass through between the power source and the light. FIG. 5A is a detailed view of the circled detail C in FIG. 3B. The set of contacts 130, 132 may be biased with a steel spring, with a torsion spring, etc. The set of contacts may be formed as a single piece having the ends biased toward each other or as two separate pieces. FIG. 5B illustrates a detailed view of a set of contacts in socket 104 with a cartridge inserted into the socket. FIG. 5B is a detailed view of the circled detail D in FIG. 4B. FIG. 5B illustrates that a pin 120, also referred to herein as an extension or connection component, of the cartridge 102 presses the set of contacts 130, 132 apart and establishes an electrical path that flows through the cartridge 102. FIG. 5B illustrates that the pin 120 may have an angled or pointed end to insert between the set of contacts 130, 132.

As illustrated in FIG. 4B, the socket 104 may be configured to break a first connection between a power source and a light and to form a second connection between the power source and the cartridge 102 and a third connection between the cartridge and light upon insertion of the cartridge. When the cartridge is removed, or the socket is otherwise empty, the socket reestablishes the first connection between the power source and the light because the connectors, e.g., 130, 132, 306, 308 in the socket establish their respective connections and the light fixture functions without interruption.

The socket may be manufactured as a part of a light fixture. As the electrical connection is maintained to the light whether or not a cartridge is inserted, the socket can be provided during manufacturing the light fixture to provide the ability to insert a cartridge at a later date. A light fixture may function whether or not a cartridge is inserted into the socket.

FIG. 1 illustrates that the cartridge may comprise multiple connection components, e.g., pins 120, 122, 124, 126. Each pin 120, 122, 124, 126 may be configured for insertion between a corresponding set of contacts e.g., similar to 130, 132 at socket 104. The plurality of connection components may each be configured to couple the cartridge between multiple power line and the light. For example, a first connection component may be configured to couple the cartridge between a 277 V power line and the light. Another of the connection components may be configured to couple the cartridge between a control signal, e.g. a 10 V power line and the light.

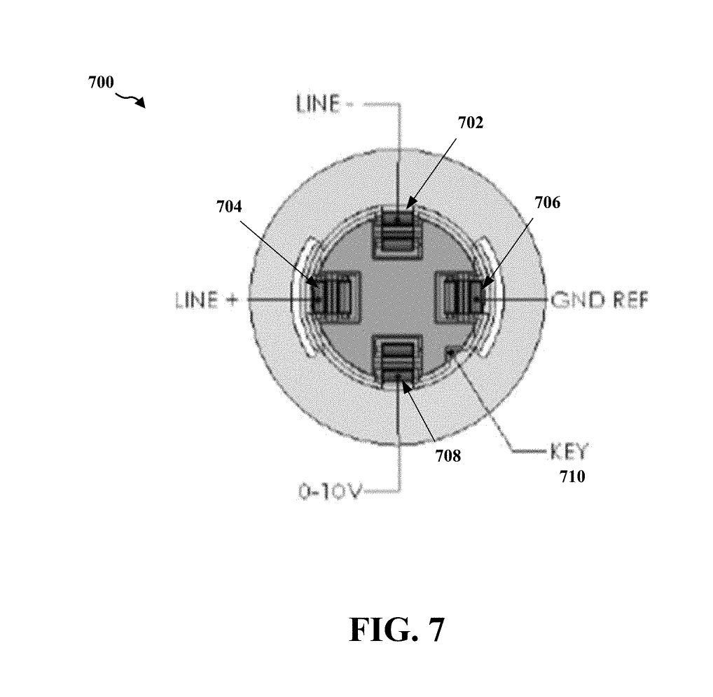

FIG. 6 illustrates an example diagram of a lighting system having a socket 604. Socket 604 may include the aspects described in connection with socket 104 of FIGS. 1-5. The lighting system 600 comprises a light 602, e.g., an LED light, and a driver 606, e.g., LED driver. While FIG. 6 illustrates an LED light, the concepts presented herein are not limited to an LED light fixture. A socket may be included in other types of light fixtures, such as fluorescent light fixtures. FIG. 6 illustrates a power line, e.g., a 277 V line 608, coupled to the light 602 and a control line 610, e.g., a 0-10V line, coupled to the light 602. Both lines 608 and 610 may be coupled to the light 602 via a driver 606. Socket 604 may be inserted between lines 608 and 610 coming in to the light 602 and driver 606. For example, the sets of contacts, e.g., 130, 132 may be coupled to lines 608, 610 using a push in wire connection, a screw plate connection, a jumper connection, etc. When the socket 604 is empty, the socket 604 may act as a pass through coupling the lines 608, 610 to the driver 606 and light 602 without any interruption. Upon insertion of a cartridge, e.g., cartridge 102, into the socket 604, the cartridge may interrupt the electrical connection of lines 608, 610 to the driver 606 and may access the power from the power lines. As illustrated, lines 608, 610 may each comprise two lines. As illustrated in FIGS. 1 and 7, socket 604 may comprise four sets of contacts, e.g., one for each line. FIG. 7 illustrates an example socket having four sets of contacts 702, 704, 706, 708. Each set of contacts may be similar to 130, 132 as described in connection with FIGS. 1-5. For example set of contacts 702 may couple to the Ground side of an AC Power Line, set of contacts 704 may couple to the Hot side of an AC Power Line, set of contacts 706 may couple to the ground side of a 0-10V control interface, and set of contacts 708 couples to the positive side of a 0-10V control interface.

FIG. 7 also illustrates key 710 that may be comprised in the housing of the socket. As illustrated in FIG. 1, the socket 104 may comprise a key, guide, or other protrusion 106 that ensures that the cartridge is inserted in the correct orientation. Cartridge 102 may comprise a corresponding indent 108 designed to match the protrusion 106 of the socket. If the cartridge is turned or rotated so that a pin 120, 122, 124, 126 would contact the incorrect set of contacts, e.g., 130, 132 of the socket 104, the protrusion 106 will block the cartridge 102 from being inserted into the socket 104 in the improper orientation. The protrusion blocks the cartridge from insertion unless the indent 108 in the cartridge is correctly aligned with the protrusion 106. The protrusion provides a physical block to improper insertion and a visual key or guide to assist the user in identifying the correct orientation of the cartridge for insertion.

The socket may comprise a clipping mechanism that holds the cartridge in position within the socket 104. The clipping mechanism may comprise a clip, snap, or other mechanism that snaps or clips the cartridge within the socket and allows the cartridge to later be withdrawn, e.g., pulled, from the socket. FIG. 1 illustrates one example where the socket 104 may comprise an extension 112 within the housing of the socket that are configured to fit within a corresponding indentation 114 at the cartridge when the cartridge is inserted into position within the socket 104. Multiple extensions 112 may be provided within the socket, with corresponding multiple indentations 114 at the cartridge. FIGS. 1, 3B, and 4B illustrate a set of two extensions 112 and indentations 114. However, this is merely an example, and other numbers of indentations or extensions may be provided. FIG. 3B illustrates that slots 312 may be provided in the housing 107 of the socket adjacent the extensions 112, which allow the body of the socket to flex somewhat to allow the cartridge to be moved into the socket 104. The indent 114 at the cartridge assists in holding the cartridge 114 within the socket 112 yet allow the cartridge to be pulled out of the socket. Another holding mechanism, such as a snap, latch, cover piece, may be used to maintain the position of the cartridge relative to the socket.

Although the example, in FIG. 1 illustrates a cylindrical cartridge and socket, this is merely one example, and the cartridge and socket may be rectangular, triangular, or any other shape.

FIG. 1 illustrates the socket 104 having a flange 110 surrounding the opening. The socket 104 may be positioned such that a flange surrounding opening is substantially flush with the housing of the light fixture, and the remaining portion of the socket extends within the housing of the lighting fixture. This may enable easy access to the socket and maintain the profile of the light fixture. In lighting fixtures mounted at level with the ceiling 402 or at, the flange may be at a level of the ceiling, as illustrated in FIGS. 3B and 4B. In other examples, the housing 107 of the socket may be positioned interior to the light fixture with the flange 110 substantially flush with the housing of the light fixture.

The socket may be configured to connect to the light fixture. The socket may click or snap into position with the light fixture. The socket not only couples to the housing of the light fixture, but also establishes an electrical connection with the power source powering the light fixture. This electrical connection between the socket and the light fixture power lines may comprise a push in wire connection, a screw plate connection, a jumper connection, etc. The socket may be incorporated into the light fixture at the time of manufacture.

As the light fixture operates without interruption when the socket is empty, the light fixture may be purchased, installed, and used without a cartridge. At a later date, a cartridge can be inserted into the socket at light fixture. Alternately, the light fixture may be installed with a cartridge inserted into the socket. If it is desired to remove the cartridge, the cartridge may be removed without interrupting the operation and the light fixture. The cartridge may be replaced with an upgraded cartridge. Therefore, as technology changes, a light fixture need not be replaced, but an upgraded cartridge may simply be inserted in place of an older cartridge. Additionally, cartridges may be moved to different light fixtures, e.g., a different location in a retail store, simply by pulling the cartridge out and inserting it into a new socket at a different light fixture.

The socket may be provided in different types of light fixtures.

For example, in a down light, the socket may be configured so that the initial opening to receive the cartridge is positioned at the light emitting side of the light fixture, e.g., at a level with the ceiling. A movable cover may be provided over the opening of the socket. The cover may rotate, swing, slide, or otherwise move away from the opening to enable insertion of the cartridge into the socket. The cover may be fixed to the socket in a manner that it can slide or rotate out of the way. In an alternative, the cover may be removable from the socket.

In another example, the light fixture may comprise a linear fixture, such as a troffer light configured to be recessed above the ceiling grid or provided in surface mount boxes. In this example, the socket opening may be provided at a portion of the light that is substantially level with the ceiling.

In another example, the socket may be provided in a track lighting light fixture. The opening of the socket may be provided in a side portion of the track for the track lighting, and the body of the socket may be housed within the track.

In another example, the socket may be provided in a linear pendant type of light fixture. In this example, the body of the socket may be housed above the ceiling level, with the socket opening at ceiling level.

The insertable cartridge may comprise any of a number of components and capabilities. Different cartridges may be configured to provide with different components in order to provide different capabilities. As technology changes, upgraded cartridges may be used to simply replace an older cartridge. A cartridge may be removed from a light fixture by pulling the cartridge out of the socket. The new cartridge may then be inserted. No electrician is required. The new cartridge automatically connects to the power of the light fixture and begins operation automatically.

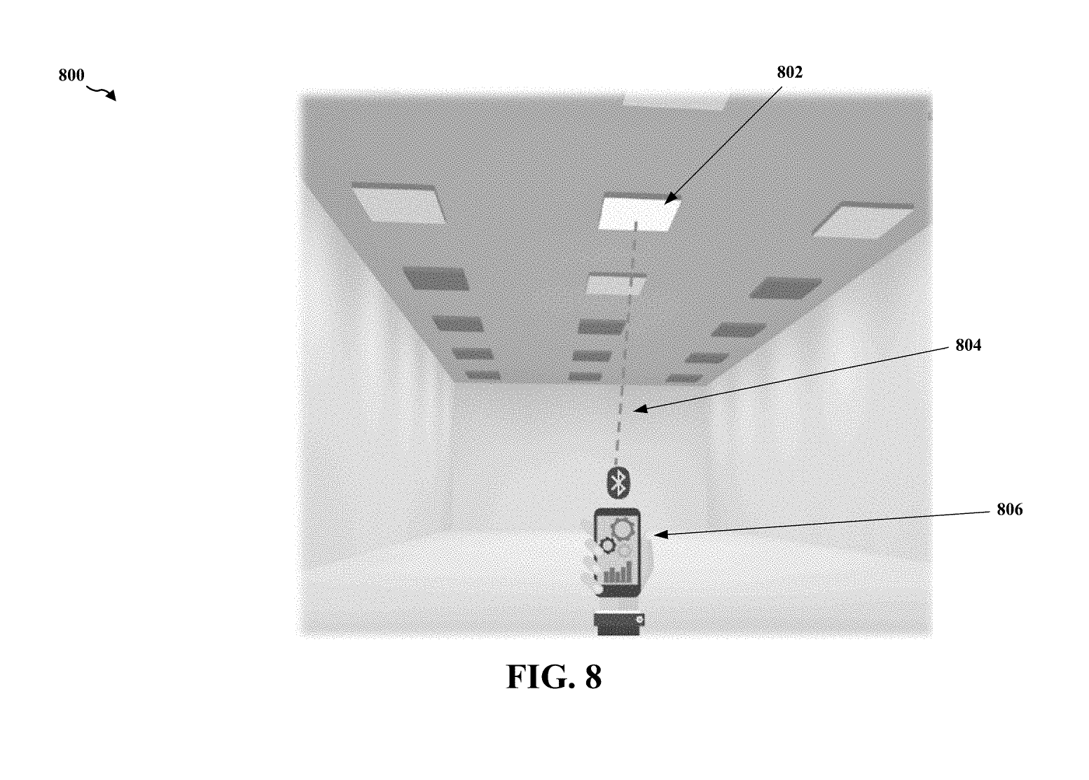

In one example, components within the cartridge may provide power management for the light fixture. The cartridge may be configured to manage power provided from the power source, e.g., 608, 610, to the light, e.g., 602. For example, the cartridge may control the light fixture based on wireless communication with a remote operator. As another example, the cartridge may provide local control of a light fixture that overrides control of the light fixture via a control line. As the cartridge may interrupt the control line, e.g., 610, supplied to the light fixture, the cartridge may provide a different control to the light fixture based on a local wireless signal. For example, as illustrated in FIG. 8, the cartridge at light fixture 802 may receive a Bluetooth signal 804 from a wireless device 806 that provides instructions for control of light fixture 802.

Components within the cartridge may also provide power transformation. Components within the cartridge may provide connectivity for any of a number of connections. The cartridge may provide a radio connection, a data connection, etc. For example, the cartridge may comprise a wireless transceiver. The cartridge may enable Internet of Thing (IoT) wireless communication. The cartridge may comprise a radio capable of wireless communication, e.g., via Bluetooth, WiFi, and/or cellular communication. The cartridge may comprise a wireless beacon or may operate as a wireless beacon. The cartridge may provide network connectivity to other devices, e.g., wireless device 806 in FIG. 8. Each of these features, and any others may be powered using the power connection for the light fixture via the socket at the light fixture. For example, the beacon component within a cartridge may be powered by insertion of the cartridge into a light fixture rather than using a battery or an independent electrical connection.

The light fixture is adaptable. By providing a socket in a light fixture at the time of manufacture, at any later date, a cartridge may be inserted, removed, upgraded, etc. The cartridge forms a removable driver that is powered upon insertion into the socket. Upon the light functions normally.

The cartridge may comprise additional components, including among others any of a camera, an audio device, various sensors, etc. Among others, such sensors may include an air quality sensor, a thermal sensor, a light and/or temperature sensor, and a motion sensor.

A power path may be provided within the cartridge so that once a connection is established with the power source via the socket, the path provides power to various components within the cartridge. The power from the power source may be provided on a path through the cartridge to power various components within the cartridge.

The cartridge may be modular so that it can be extended by connection to other modular cartridges. The cartridge may be configured to receive additional modules that provide added functionality. A first end of the cartridge may include the connectors to establish a power connection via the socket, and a second end opposite the first end, may comprise a connection similar to the set of contacts 130, 132 of the socket. The additional module may comprise an connection component portion, similar to 118 in cartridge 102 in FIG. 1. The additional module may comprise an additional sensor, a camera, an additional transceiver, etc.

When no additional module is inserted, the cartridge functions normally, running power through the cartridge and back to the light. Upon insertion of an additional module into the receiving end of the cartridge, the cartridge provides power to the additional module.

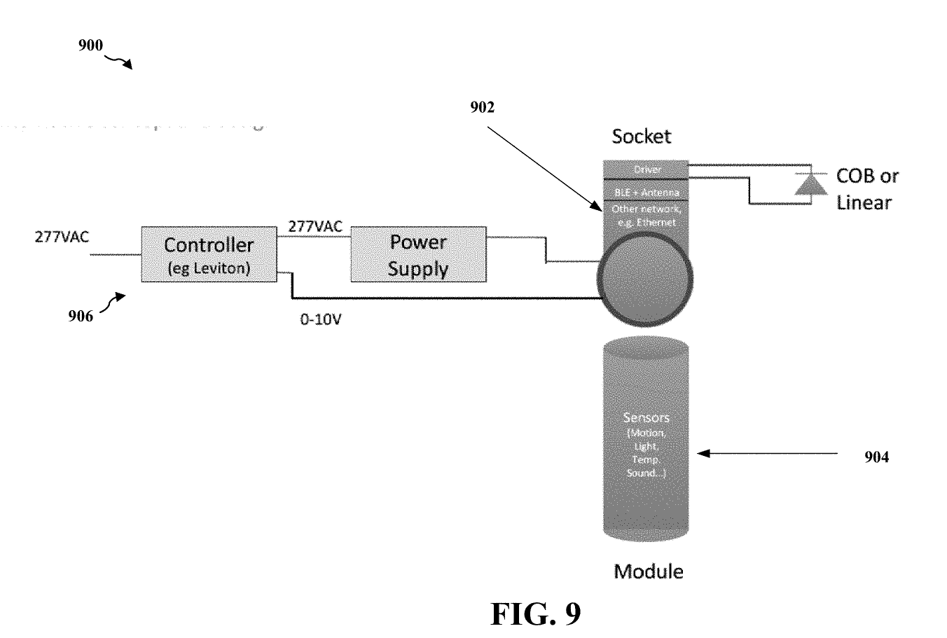

FIG. 9 illustrates an example system 900 comprising a modular, extendable cartridge 902. The cartridge may be inserted into a socket at a light source provided between a power source 906 and a light. As illustrated, the power source may comprise both a 277 V AC power supply and a control line of 1-10 V supplied via a controller. In other examples, the power supply may comprise only a 277 V AC power supply without an additional control line. The cartridge 902 may comprise a first set of components, e.g., a driver, a Bluetooth antenna, and other network connectivity, e.g., an Ethernet connection. The cartridge 902 may be configured to connect to a module 904. The module 904 may be configured as an additional cartridge 902. Thus, a cartridge 902 may be configured to be extendable by receiving or coupling to additional cartridges 904. The module 904 may comprise additional sensors or components that provide added functionality to that provided by the initial cartridge 902.

In another example, component 902 may comprise a socket that comprises components to provide a limited number of features. The socket may be configured to receive a cartridge with added functionality, e.g., included additional sensors, cameras transmitters, etc.

A portion of the cartridge, e.g., domed portion 140 illustrated in FIGS. 1 and 4B, may be configured to extend beyond the socket 104 when the cartridge 102 is fully inserted into the socket. This extending portion 140 may comprise an antenna for reception/transmission. Providing this antenna in a portion that extends outside the socket may improve signal quality for the antenna. For example, FIG. 4B illustrates that the socket may be positioned with the flange 110 flush with the ceiling 402. The extension portion 140 of the cartridge may then extend below the flange 110 and ceiling 402 enabling between transmission/reception at the antenna. In other examples, the portion 140 of the cartridge may comprise a camera or a sensor that would benefit from placement in portion 140 that extends below the flange 110 of the socket 104 and below the ceiling 402.

In a modular design, it may be beneficial to have the extending portion 140 of the cartridge be configured to be removable so that additional modules can be inserted between the cartridge and the antenna rather than blocking the reception of the antenna. The extending portion 140 comprising the antenna may then be connected at the end of the additional module/cartridge. This enables the antenna to be maintain its position at the end of the extended cartridge even when additional modules are inserted.

Several aspects have been presented with reference to various capabilities of the cartridge. These aspects may be implemented using, in part, electronic hardware, computer software, or any combination thereof housed in the cartridge and powered by the connection established at the socket. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer.

Example aspects have now been described in accordance with the above advantages. It will be appreciated that these examples are merely illustrative of aspects of the present invention. Many variations and modifications will be apparent to those skilled in the art.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An insertable cartridge for removable connection with a docking station at a light fixture, the insertable cartridge comprising:
a connection component configured to couple between at least one power source and a light at the light fixture when inserted into the docking station; and
a wireless transceiver configured to operate as a wireless node powered via the connection component.

2. The insertable cartridge of claim 1, wherein the connection component comprises an extension that extends from a housing of the cartridge, wherein, upon insertion into the docking station, the extension is configured to:
interrupt a first connection between the power line and the light;
couple the power line to the cartridge via a first connection; and
couple the cartridge to the light via a second connection.

3. The insertable cartridge of claim 1, comprising a plurality of connection components, each configured to couple the cartridge between either a different power line or a control signal and the light.

4. The insertable cartridge of claim 3, wherein the plurality of connection components include a first connection component configured to couple the cartridge between a 277 V power line and the light.

5. The insertable cartridge of claim 3, wherein the plurality of connection components include a first connection component configured to couple the cartridge between a control signal and the light.

6. The insertable cartridge of claim 1, wherein the insertable cartridge is configured to provide a network connection to at least one sensor, wherein the network connection is powered via the connection component.

7. The insertable cartridge of claim 1, further comprising:
at least one sensor coupled to the wireless transceiver, wherein the at least one sensor is powered via the connection component.

8. The insertable cartridge of claim 7, wherein the at least one sensor comprises at least one of a beacon, a camera, a speaker, an air quality sensor, a thermosensor, a light sensor, a motion sensor, a microphone, and a humidity sensor.

9. The insertable cartridge of claim 1, further comprising:
a modular connection configured to couple to a modular cartridge component and to establish an electrical connection through the modular cartridge component when the modular cartridge component is coupled to the insertable cartridge.

10. The insertable cartridge of claim 1, further comprising at least one processor configured to perform at least one of control of the light, measurement of a control line to the light, and power management of the light.

11. The insertable cartridge of claim 1, further comprising:
an extending portion configured to extend outside of the docking station when the cartridge is received into the docking station.

12. The insertable cartridge of claim 11, further comprising:
an antenna positioned within the extending portion.

13. An insertable cartridge for removable connection with a docking station at a light fixture, the insertable cartridge comprising:
a connection component configured to couple between at least one power source and a light at the light fixture when inserted into the docking station; and
a power management component that is powered via the connection component.

14. The insertable cartridge of claim 13, wherein the connection component couples between a control signal and the light, and wherein the power management component is configured to control the light.

15. The insertable cartridge of claim 14, wherein the power management component is configured to override control of the light received via the control signal.

16. The insertable cartridge of claim 13, further comprising at least one of a sensor, a transceiver, a beacon, a speaker, and a camera controlled by the power management component.

17. The insertable cartridge of claim 13, wherein the connection component comprises an extension that extends from a housing of the cartridge, wherein, upon insertion into the docking station, the extension is configured to:
interrupt a first connection between the power line and the light;
couple the power line to the cartridge via a first connection; and
couple the cartridge to the light via a second connection.

18. A powered socket comprising:
an opening configured to receive a removable cartridge; and
a power connection coupled to at least one power line between a power source and a light,
wherein the power connection is configured to couple the removable cartridge to the at least one power line between the power source and the light when a cartridge is received into the powered socket, and
wherein the power connection is configured to form a coupling between the power source and the light when the removable cartridge is removed from the powered socket.

19. The powered socket of claim 18, wherein the power connection comprises a first set of contacts comprising a first contact biased toward a second contact to form a first electrical connection,
wherein receipt of the cartridge into the powered socket presses the first contact and second contact apart, breaking the first electrical connection, and
wherein upon removal of the cartridge from the powered socket, the first contact and the second contact reestablish the first electrical connection.

20. A light fixture comprising:
a housing;
a light provided within the housing; and
a socket comprising:
an opening configured to receive a removable cartridge; and
a power connection coupled to at least one power line between a power source and the light,
wherein the power connection is configured to couple the removable cartridge to the at least one power line between the power source and the light when a cartridge is received into the powered socket, and
wherein the power connection is configured to form a coupling between the power source and the light when the removable cartridge is removed from the powered socket.

21. The light fixture of claim 20, further comprising:
an LED driver, wherein the socket is positioned between an LED driver and the power source for the LED driver.

22. The light fixture of claim 21, wherein the power source comprises a 277 V power line.

23. The light fixture of claim 22, wherein the power source comprises a control signal.

24. The light fixture of claim 20, further comprising:
a removable cartridge inserted into the socket, the removable cartridge comprising:
a connection component configured to couple the power source and the light when the removable cartridge is inserted into the socket; and
a wireless transceiver configured to operate as a wireless node powered via the connection component.
